(19) United States
(12) Patent Application Publication
(10) Pub. No.: US 2021/0182843 A1
(43) Pub. Date: Jun. 17, 2021

(54) SETTLEMENT PROCESSING METHOD AND SETTLEMENT PROCESSING SYSTEM

(71) Applicant: KDDI CORPORATION, Tokyo (JP)

(72) Inventors: Tomohiro OKUYAMA, Tokyo (JP); Tooru SHIMIZU, Tokyo (JP)

(73) Assignee: KDDI CORPORATION, Tokyo (JP)

(21) Appl. No.: 17/268,223

(22) PCT Filed: Sep. 18, 2019
(86) PCT No.: PCT/JP2019/036436

§ 371 Date: Feb. 12, 2021

(30) Foreign Application Priority Data
Sep. 27, 2018 (JP) 2018-181850
Sep. 27, 2018 (JP) 2018-181851

(51) Int. Cl. G06Q 20/38; G06Q 20/40; G06Q 20/08

(52) U.S. Cl. CPC G06Q 20/385; G06Q 20/4014; G06Q 2220/00; G06Q 20/085; G06Q 20/3829

(57) ABSTRACT

A first user terminal used by a first user is configured to transmit a request for acquiring a settlement token to a first settlement server managed by a first settlement service provider available to the first user. The first settlement server generates a settlement token associated with a first service provider identifier for identifying the first settlement service provider and is configured to transmit the settlement token to the first user terminal. The first user terminal is configured to display a settlement code generated on the basis of the settlement token. A second user terminal registered in a second settlement server managed by a second settlement service provider different from the first settlement service provider is configured to transmit settlement information including a settlement token and a settlement price obtained by reading the settlement code to a relay server. The relay server acquires the first service provider identifier associated with the settlement token. The relay server is configured to transmit the settlement token to the first settlement sever generating the settlement token.

### TECHNICAL FIELD

The present invention relates to a settlement processing method and a settlement processing system and, in particular, to a technology for performing a settlement process using a settlement code.

Priority is claimed on Japanese Patent Application No. 2018-181850 and Japanese Patent Application No. 2018-181851, filed Sep. 27, 2018, the contents of which are incorporated herein by reference.

### BACKGROUND ART

Electronic settlement in which settlement is electronically carried out without using commodity money such as bills and coins has become widespread. In electronic settlement, users paying prices of commodities or services are authenticated as a precondition for settlement. However, structures for realizing authentication processes by reading imaged codes with code readers such as cameras in user authentication have become widespread (for example, see Patent Document 1).

### PRIOR ART DOCUMENT

### Patent Document

### [Patent Document 1]

Published Japanese Translation No. 2017-503253 of the PCT International Publication

### SUMMARY OF INVENTION

### Problems to be Solved by the Invention

According to the technology disclosed in Patent Document 1, an authentication process is performed based on information embedded in a barcode or a QR code (registered trademark). However, standards of structures for embedding in codes or encoding of information are in disarray and different kinds of standards have not been compatible in some situations. Therefore, users who want to use the foregoing electronic settlement may be at a loss as to what standard for electronic settlement should be used. As a result, the spreading of electronic settlement can be disturbed.

The present invention has been achieved in view of such circumstances and an objective of the present invention is to provide a technology for a user who carries out settlement without being aware of the kind of electronic settlement.

### Means for Solving the Problems

According to a first aspect of the present invention, a settlement processing method includes: transmitting a request for acquiring a settlement token to a first settlement server managed by a first settlement service provider available t a first user by a first user terminal used by the first user; transmitting a settlement token associated with a first service provider identifier for identifying the first settlement service provider to the first user terminal by the first settlement server; displaying a settlement code generated on the basis of the settlement token by the first user terminal; transmitting settlement information including a settlement token and a settlement price obtained by reading the settlement code to a relay server by a second user terminal registered in a second settlement server managed by a second settlement service provider different from the first settlement service provider; acquiring the first service provider identifier associated with the settlement token by the relay server; transmitting the settlement token to the first settlement sever generating the settlement token by the relay server; and performing user authentication of the first user on the basis of the settlement token by the first settlement server.

According to a second aspect of the present invention, a settlement processing method includes: transmitting a request for acquiring a settlement token to a first settlement server managed by a first settlement service provider available to a first user by a first user terminal used by the first user; transmitting a token associated with a first service provider identifier for identifying the first settlement service provider to the first user terminal by the first settlement server; displaying a settlement code generated on the basis of the settlement token by the first user terminal; transmitting settlement information including a settlement token and a settlement price obtained by reading the settlement code to a second settlement server managed by a second settlement service provider available to a second user using a second user terminal by the second user terminal; transmitting the settlement information received to a relay server by the second settlement server by the second user terminal; extracting the first service provider identifier from the settlement token included in the settlement information received from the second settlement server by the relay server; transmitting the settlement token to the first settlement server managed by the first settlement service provider identified with the first service provider identifier by the relay server; and authenticating the first user on the basis of the settlement token by the first settlement server.

According to a third aspect of the present invention, a settlement processing method includes: transmitting a request for acquiring a settlement token to a first settlement server managed by a first settlement service provider available to a first user by a first user terminal used by the first user; encrypting a settlement token associated with a first service provider identifier for identifying the first settlement service provider using a first encryption key which is an encryption key used by the first settlement server and transmitting the encrypted settlement token to the first user terminal by the first settlement server; decoding the encrypted settlement token received from the first settlement server using the first encryption key by the first user terminal; displaying a settlement code generated on the basis of the settlement token by the first user terminal; encrypting settlement information including a settlement token and a settlement price obtained by reading the settlement code using a second encryption key which is an encryption key used by the first settlement server and transmitting the encrypted settlement information to a relay server by a second user terminal registered in a second settlement server managed by a second settlement service provider different from the first settlement service provider; decoding the encrypted settlement information received from the second user terminal using the second encryption key by the relay server; acquiring the first service provider identifier associated with the settlement token included in the settlement information obtained through the decoding by the relay server; encrypting the settlement token included in the decoded settlement information using the first encryption key by the relay server; transmitting the encrypted settlement token to the first settlement server generating the settlement token by the relay server; decoding the encrypted settlement token acquired from the relay server using the first encryption key by the first settlement server; and performing user authentication of the first user on the basis of the decoded settlement token by the first settlement server.

The settlement processing method according to the first to third aspects of the present invention may further include: generating a token associated with the first service provider identifier for identifying the first settlement service provider and transmitting the token to the relay server by the first settlement server; and stopping the settlement process by the relay server when the settlement token received from the first settlement server does not match the settlement token received from the second user terminal.

According to a fourth aspect of the present invention, a settlement processing method includes: transmitting a request for acquiring a settlement token for performing settlement using a first settlement server managed by a first settlement service provider available to a first user to a relay server by a first user terminal used by the first user; transmitting a token associated with a first service provider identifier for identifying the first settlement service provider to the first user terminal by the relay server; displaying a settlement code generated on the basis of the settlement token by the first user terminal; transmitting settlement information including the settlement token and a settlement price obtained by reading the settlement code to the relay server by the second user terminal; acquiring the first service provider identifier associated with the settlement token by the relay server; transmitting the settlement token to the first settlement server generating the settlement token by the relay server; and authenticating the first user on the basis of the settlement token by the first settlement server.

According to a fifth aspect of the present invention, a settlement processing method includes: receiving a request for acquiring a settlement token for performing settlement using a first settlement server managed by a first settlement service provider available to a first user from a first user terminal used by the user; transmitting a token associated with a first service provider identifier for identifying the first settlement service provider to the first user terminal; receiving settlement information including a settlement token and a settlement price obtained by reading a settlement code generated by the first user terminal on the basis of the settlement token from a second user terminal reading the settlement code; transmitting the settlement token to a first settlement server which is a settlement server of a settlement service provider corresponding to the settlement token; and receiving information regarding a settlement approval which is based on the settlement token from the first settlement server.

According to a sixth aspect of the present invention, a settlement processing method includes: transmitting a request for acquiring a settlement token to a first settlement server managed by a first settlement service provider and available in a store by a store terminal installed in the store; transmitting a settlement token associated with a first service provider identifier for identifying the first settlement service provider to the store terminal by the first settlement server; displaying a settlement code generated on the basis of the settlement token by the store terminal; acquiring a settlement token obtained by reading the settlement code by a customer terminal which is a terminal of a customer using the store; encrypting settlement information including the settlement token and a settlement price with an encryption key used by the first settlement server by the customer terminal; transmitting the encrypted settlement information to the relay server by the customer terminal; transmitting the settlement information received from the customer terminal to the first settlement server by the relay server; and performing user authentication on the basis of the settlement information transmitted from the relay server by the first settlement server.

The settlement processing method according to the sixth aspect of the present invention may further include: generating a settlement token including a first service provider identifier for identifying the first settlement service provider and transmitting the settlement token to the relay server by the first settlement server; and stopping a settlement process by the relay server when the settlement token received from the first settlement server does not match a settlement token received from the customer terminal.

According to a seventh aspect of the present invention, a settlement processing method includes: transmitting a request for acquiring a settlement token for performing settlement using a first settlement server managed by a first settlement service provider and available in a store to a relay server by a store terminal installed in the store; transmitting a settlement token associated with a first service provider identifier for identifying the first settlement service provider to the store terminal by the relay server; displaying a settlement code generated on the basis of the settlement token by the store terminal; acquiring the settlement token obtained by reading the settlement code by a customer terminal which is a terminal of a customer using the store; encrypting settlement information including the settlement token and a settlement price with an encryption key used by the first settlement server by the customer terminal; transmitting the encrypted settlement information to the relay server by the customer terminal; transmitting the settlement information acquired from the customer terminal to the first settlement server by the relay server; and performing user authentication on the basis of the settlement information transmitted from the relay server by the first settlement server.

According to an eighth aspect of the present invention, a settlement processing system includes: a store terminal installed in a store; a customer terminal carried by a customer using the store; a settlement server managed by a first settlement service provider and available in the store, the first settlement service provider different from a second settlement service provider available to the customer terminal; and a relay server. The store terminal includes a token request unit and a display control unit. The settlement server includes a token transmission unit and a settlement management unit. The customer terminal includes a code reading unit, a settlement information transmission unit, and an encryption unit. The relay server includes a settlement request unit. The token request unit of the store terminal is configured to transmit a request for acquiring a settlement token to the settlement server. The token transmission unit of the settlement server is configured to transmit a settlement token associated with a first service provider identifier for identifying the first settlement service provider to the store terminal. The display control unit of the store terminal is configured to display a settlement code generated on the basis of the settlement token on a display unit. The code reading unit of the customer terminal reads the settlement code displayed on the display unit of the store terminal. The encryption unit of the customer terminal is configured to encrypt settlement information including the settlement token and a settlement price with an encryption key used by the settlement server. The settlement information transmission unit of the customer terminal is configured to transmit the settlement information encrypted by the encryption unit to the relay server. The settlement request unit of the relay server is configured to transmit the settlement information acquired from the customer terminal to the settlement server. The settlement management unit of the settlement server performs user authentication on the basis of the settlement information transmitted from the relay server.

### Advantageous Effects of the Invention

According to the present invention, it is possible to provide a technology for a user who carries out settlement without being aware of a kind of electronic settlement.

### BRIEF DESCRIPTION OF DRAWINGS

FIG. 1 is a diagram illustrating a preliminary registration process performed by a settlement processing system according to a first embodiment.

FIG. 2 is a block diagram illustrating a functional configuration of each device included in the settlement processing system according to the first embodiment.

FIG. 3 is a diagram illustrating a settlement process performed by the settlement processing system according to the first embodiment.

FIG. 4 is a table schematically illustrating the data structure of a settlement token database stored in a storage unit according to the first embodiment.

FIG. 5 is a diagram illustrating a settlement process performed by the settlement processing system according to a first modification example of the first embodiment.

FIG. 6 is a diagram illustrating a settlement process performed by the settlement processing system according to a second modification example of the first embodiment.

FIG. 7 is a diagram illustrating a settlement process performed by the settlement processing system according to a third modification example of the first embodiment.

FIG. 8 is a diagram illustrating a settlement process performed by the settlement processing system according to a fourth modification example of the first embodiment.

FIG. 9 is a diagram illustrating a settlement process performed by the settlement processing system according to a fifth modification example of the first embodiment.

FIG. 10 is a diagram illustrating a settlement process performed by the settlement processing system according to a sixth modification example of the first embodiment.

FIG. 11 is a block diagram illustrating a functional configuration of each device included in a settlement processing system according to a second embodiment.

FIG. 12 is a diagram illustrating a settlement process performed by the settlement processing system according to the second embodiment.

### EMBODIMENTS FOR CARRYING OUT THE INVENTION

### First Embodiment

### Overview of First Embodiment

An overview of a first embodiment will be described. A relay server according to the first embodiment is a device that relays electronic settlement in which a QR code or the like is used. A relay server according to the first embodiment relays exchange of information among four parties, a user terminal used by a user who tries to carry out electronic settlement, a store terminal installed in a store which the user uses, a settlement server of a settlement service provider available to the user, and a settlement server of a settlement service provider which the store can use.

Here, a technology for electronic settlement in which a code is used is broadly classified into two types of schemes, a “user suggestion scheme” and a “store suggestion scheme.” The “user suggestion scheme” is a scheme in which the store terminal reads a code displayed on the user terminal of the user using the store and transmits the code to the settlement server. The “store suggestion scheme” is a scheme in which the user terminal reads a code displayed on the store terminal and transmits the code to the settlement server.

Hereinafter, in the first embodiment, a user of a terminal displaying a code is referred to as a “first user,” a terminal used by the first user is referred to as a “first user terminal,” a settlement service provider with which the first user makes a contract is referred to as a “first settlement service provider, and a settlement server managed by the first settlement service provider is referred to as a “first settlement server.” A terminal reading a code displayed by the first user terminal is a “second user terminal,” a user using the second user terminal is referred to as a “second user,” a settlement service provider with which the second user makes a contract is referred to as a “second settlement service provider,” and a settlement server managed by the second settlement service provider is referred to as a “second settlement server.”

Accordingly, in a settlement system of the user suggestion scheme, a user terminal of a user using a store is the first user terminal and a store terminal installed in the store used by the user is the second user terminal. In this case, the second user is a manager or the like of the store. In a settlement system of the store suggestion scheme, a user terminal of a user using a store is the second user terminal and a store terminal installed in the store used by the user is the first user terminal.

In general, information exchanged for a settlement service provider of a certain electronic settlement to perform settlement with each user terminal is encrypted with an encryption key used individually by each settlement service provider. Accordingly, when the first settlement service provider and the second settlement service provider are different, the second settlement service provider cannot normally carry out the settlement process although the second settlement service provider receives settlement information encrypted with an encryption key used by the first service provider to communicate with the first settlement service provider.

The relay server according to the first embodiment is configured to acquire the encryption key used by each settlement service provider from a plurality of settlement service providers in advance and read encrypted information which is used in communication by each company. Therefore, the relay server according to the first embodiment can receive settlement information including a token for the first settlement server transmitted by the first user terminal, read content of the settlement information, and transmit the settlement information to the second settlement server.

In this way, the relay server according to the first embodiment can realize the settlement process by relaying settlement between both service providers even when a settlement service provider of the electronic settlement with which a user trying to carry out the electronic settlement makes a contract is different for a settlement service provider with which a store used by the user makes a contract. Accordingly, the relay server according to the first embodiment can carry out settlement so that the user is not aware of the kind of electronic settlement.

### <Preliminary Registration Process>

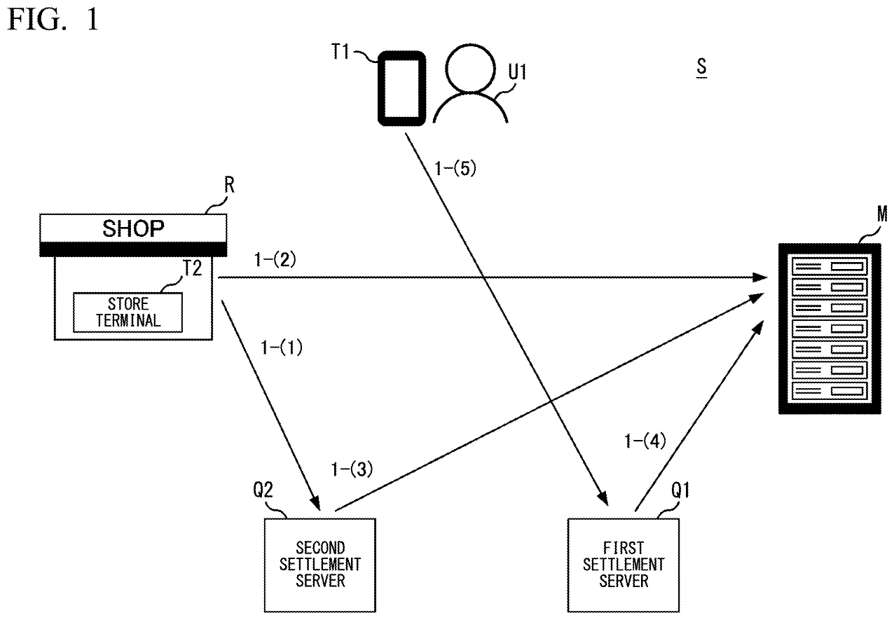

FIG. 1 is a diagram illustrating a preliminary registration process of a settlement processing system S according to the first embodiment. Hereinafter, to facilitate description, the settlement processing system S is assumed to be a system that processes settlement of the user suggestion scheme in the following description.

As illustrated in FIG. 1, the settlement processing system S according to the first embodiment includes a first user terminal T1 which is a terminal used by a first user U1, a second user terminal T2 which is a terminal installed in a store R used by the first user U1, a first settlement server Q1 which is a settlement server Q managed by a settlement service provider with which the first user U1 makes a contract, a second settlement server Q2 which is a settlement server Q of a settlement service provider with which a second user U2 who is a manager of the store R makes a contract, and a relay server M.

Hereinafter, a preliminary registration process of the settlement processing system S according to the first embodiment will be described in the order of 1-(1) to 1-(5) with reference to FIG. 1. These reference numbers correspond to 1-(1) to 1-(5) in FIG. 1.

1-(1) The second user U2 carries out user registration to the second settlement server Q2 managed by the second settlement service provider in order to use an electronic settlement service provided by the second settlement service provider. Thus, the second user U2 opens an electronic settlement account managed by the second settlement server Q2.

1-(2) The second user U2 performs user registration in the relay server M.

1-(3) The second settlement service provider carries out service provider registration in the relay server M and the second settlement service provider supplies an encryption key for encrypting information in communication to the relay server M.

1-(4) The first settlement service provider carries out service provider registration in the relay server M and the first settlement service provider supplies an encryption key for encrypting information in communication to the relay server M.

1-(5) The first user U1 carries out user registration in the first settlement server Q1 managed by the first settlement service provider in order to use an electronic settlement service provided by the first settlement service provider. Thus, the first user U1 opens an electronic settlement account managed by the first settlement server Q1.

Here, the “settlement token” is a random character string transmitted to the first user terminal T1 of the first user U1 by the first settlement server Q1 when the first user U1 tries to carry out settlement in the first settlement server Q1. The first settlement server Q1 generates each settlement token so that a settlement token to be transmitted to each first user U1 is not duplicate. The first settlement server Q1 generates a settlement token when there is a request from the first user terminal T1 and stores the settlement token in a storage unit in association with a user identifier of the first user U1.

The first settlement server Q1 determines a valid period in each settlement token to be issued. The first settlement server Q1 deletes the settlement token of which the valid period has expired from the storage unit. The valid period may be determined in consideration of security or the like required for settlement and is in a range, for example, from several minutes to tens of minutes.

The first user terminal T1 generates a settlement code (for example, an image such as a QR code or a bar code) based on the settlement token and displays the settlement code on a display unit of the first user terminal T1. When the settlement code can be read by the second user terminal T2 and can be transmitted along with a settlement price to the first settlement server Q1, the first settlement server Q1 can identify the first user U1 from the user identifier associated with the received settlement token. When the first user U1 can be identified, the first settlement server Q1 can perform settlement from an account of the first user U1 at the settlement price received from the second user terminal T2.

Incidentally, when the second user U2 does not carry out user registration to use the electronic settlement service of the first settlement service provider, there is no method of transmitting the settlement information to the first settlement server Q1 although the second user terminal T2 reads the settlement code displayed on the display unit by the first user terminal T1 reads.

In general, encrypted information is exchanged between the user terminal T and the settlement server Q, but an encryption key used for each settlement server Q to encrypt the information is mutually different. Accordingly, when the second user U2 does not carry out member store registration in order to use the electronic settlement service of the first settlement service provider, the second user terminal T2 does not have an encryption key used by the first settlement server Q1 although the second user terminal T2 reads the settlement code displayed on the display unit by the first user terminal T1. Therefore, the settlement code cannot be encrypted so that the settlement code can be decoded by the first settlement server Q1.

Accordingly, the relay server M relays transmission and reception of information between the second user terminal T2 and the first settlement server Q1, converts information received from the second user terminal T2 into information which can be handled by the first settlement server Q1, and transmits the converted information to the first settlement server Q1. Thus, the relay server M cab realize the electronic settlement although a kind of electronic settlement for which the first user U1 makes a contract is different from a kind of electronic settlement for which the second user U2 makes a contract.

### Functional Configuration of Settlement Processing System S According to First Embodiment

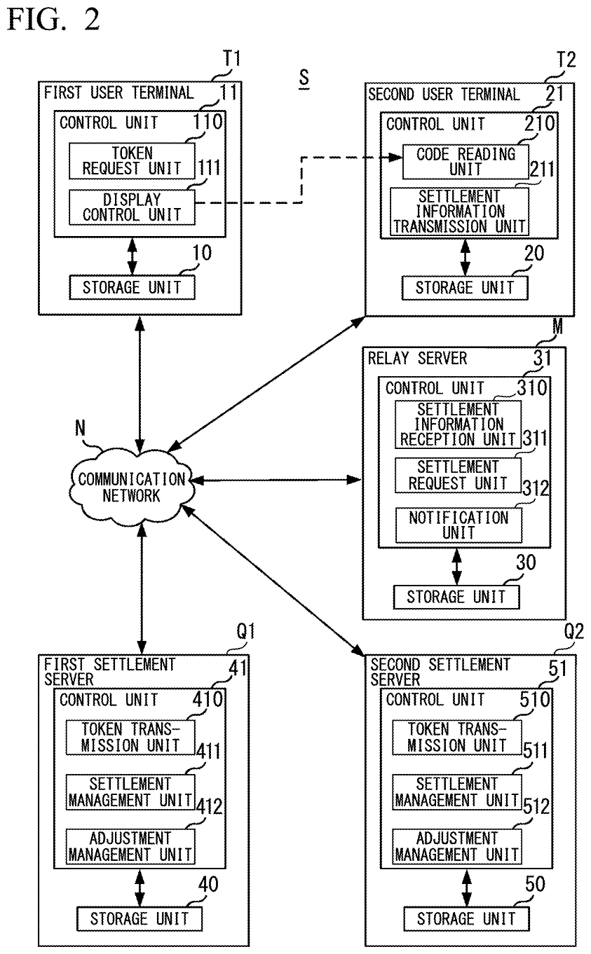

FIG. 2 is a block diagram schematically illustrating a functional configuration of each device included in the settlement processing system S according to the first embodiment. The settlement processing system S includes the first user terminal T1, the second user terminal T2, the relay server M, the first settlement server Q1, and the second settlement server Q2 which are connected to be communicable via a communication network N. The first user terminal T1 includes a storage unit 10 and a control unit 11. The second user terminal T2 also includes a storage unit 20 and a control unit 21. Similarly, the relay sever M includes a storage unit 30 and a control unit 31, the first settlement server Q1 includes a storage unit 40 and a control unit 41, and the second settlement server Q2 includes a storage unit 50 and a control unit 51.

In FIG. 2, an arrow indicates a flow of main data or may also indicate a flow of data not illustrated in FIG. 2. In FIG. 2, each functional block indicates a configuration of a function unit rather than a configuration of a hardware (device) unit. Exchange of data between the functional blocks may be performed via any means such as a data bus, a network, or a portable storage medium.

The storage unit 10 is a mass storage device such as a read-only memory (ROM) that stores a basic input output system (BIOS) or the like of a computer realizing the first user terminal T1, a random access memory (RAM) serving as a working area of the first user terminal T1, or a hard disk drive (HDD) or a solid-state drive (SSD) that stores an operating system (OS) and an application program and various kinds of information referred to in execution of the application program.

The control unit 11 is a processor such as a central processing unit (CPU) or a graphics processing unit (GPU) of the first user terminal T1 and functions as a token request unit 110 and a display control unit 111 by executing a program stored in the storage unit 10.

Similarly, the storage unit 20 is a mass storage device such as a ROM that stores a BIOS of a computer realizing the second user terminal T2, a RAM serving as a working area of the second user terminal T2, or an HDD or an SSD that stores an OS and an application program and various kinds of information referred to in execution of the application program. The control unit 21 is a processor such as a CPU or a GPU of the second user terminal T2 and functions as a code reading unit 210 and a settlement information transmission unit 211 by executing a program stored in the storage unit 20.

The storage unit 30 is a mass storage device such as a ROM that stores a BIOS of a computer realizing the relay server M, a RAM serving as a working area of the relay server M, or an HDD or an SSD that stores an OS and an application program and various kinds of information referred to in execution of the application program. The control unit 31 is a processor such as a CPU or a GPU of the relay server M and functions as a settlement information reception unit 310, a settlement request unit 311, and a notification unit 312 by executing a program stored in the storage unit 30.

The storage unit 40 is a mass storage device such as a ROM that stores a BIOS of a computer realizing the first settlement server Q1, a RAM serving as a working area of the relay server M, or an HDD or an SSD that stores an OS and an application program and various kinds of information referred to in execution of the application program. The control unit 41 is a processor such as a CPU or a GPU of the first settlement server Q1 and functions as a token transmission unit 410, a settlement management unit 411, and an adjustment management unit 412 by executing a program stored in the storage unit 40.

The storage unit 50 is a mass storage device such as a ROM that stores a BIOS of a computer realizing the second settlement server Q2, a RAM serving as a working area of the relay server M, or an HDD or an SSD that stores an OS and an application program and various kinds of information referred to in execution of the application program. The control unit 51 is a processor such as a CPU or a GPU of the second settlement server Q2 and functions as a token transmission unit 510, a settlement management unit 511, and an adjustment management unit 512 by executing a program stored in the storage unit 50.

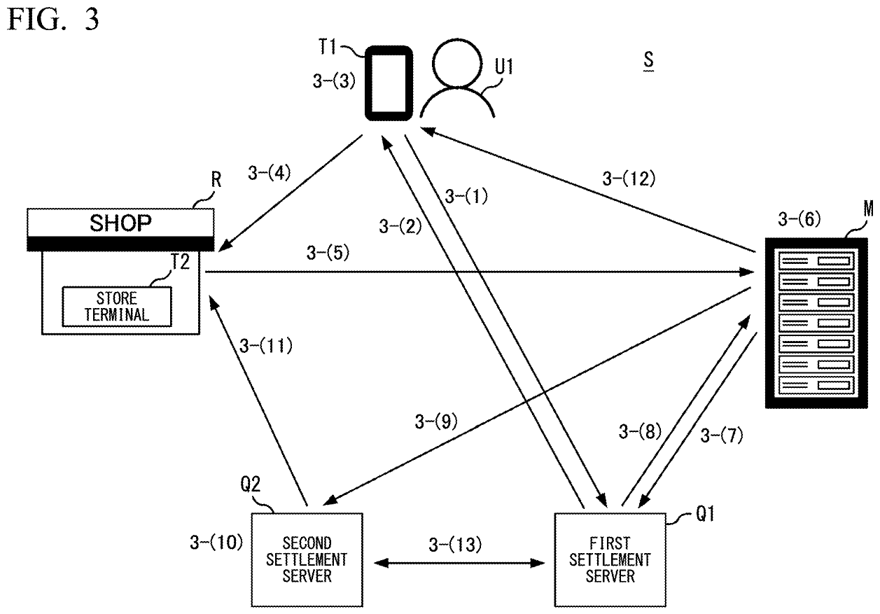

FIG. 3 is a diagram illustrating a settlement process performed by the settlement processing system S according to the first embodiment. Hereinafter, a settlement process performed by the settlement processing system S according to the first embodiment will be described in the order of 3-(1) to 3-(13) with reference to FIGS. 2 and 3. These reference numbers correspond to 3-(1) to 3-(13) in FIG. 3.

3-(1) The token request unit 110 of the first user terminal T1 transmits a request for acquiring a settlement token to the first settlement server Q1 managed by the first settlement service provider available to the first user U1.

3-(2) The token transmission unit 410 of the first settlement server Q1 generates a token associated with a first service provider identifier for identifying the first settlement service provider in response to the acquisition request acquired from the first user terminal T1 and transmits the token to the first user terminal T1. The token transmission unit 410 stores the settlement token transmitted to the first user terminal T1 in the storage unit 40 in association with a first user identifier for identifying the first user U1. The first settlement server Q1 performs user authentication of the user using the first user terminal T1 when there is a request for the token from the token request unit 110 of the first user terminal T1 or before there is the request for the token. Under the condition that the user authentication is successful, the token transmission unit 410 of the first settlement server Q1 generates the settlement token.

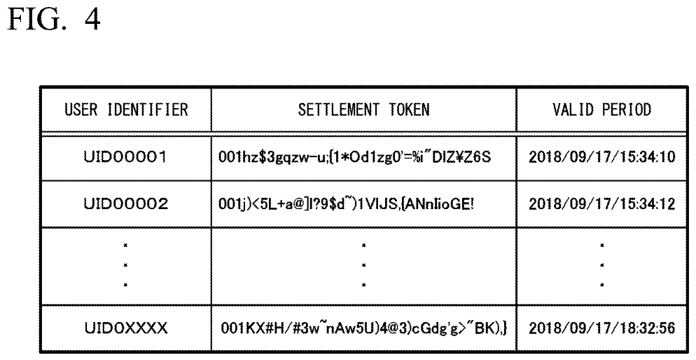

FIG. 4 is a table schematically illustrating the data structure of a settlement token database stored in the storage unit 40 according to the first embodiment. The settlement token database stores each user identifier, each settlement token, and each valid period in association.

The settlement token database illustrated in FIG. 4 is stored in the storage unit 40 of the first settlement server Q1. As illustrated in FIG. 4, the settlement token is basically a random character string and three beginning characters are a character string “001” that is common to all. The character string corresponds to the first service provider identifier. In this way, in the example illustrated in FIG. 4, the settlement token and the service provider identifier are associated in a format in which the service provider identifier is included in the settlement token. Thus, a device acquiring the settlement token can determine which settlement server Q handles the settlement token.

FIG. 3 is referred back for description.

3-(3) The display control unit 111 of the first user terminal T1 displays the settlement code generated based on the settlement token received from the first settlement server Q1 on the display unit of the first user terminal T1.

3-(4) The code reading unit 210 of the second user terminal T2 reads the settlement code displayed on the display unit of the first user terminal T1 to acquire the settlement token.

3-(5) The settlement information transmission unit 211 of the second user terminal T2 transmits settlement information including the settlement token read and acquired by the code reading unit 210, a second user identifier for identifying the second user U2 using the second user terminal T2, a settlement price, and a second service provider identifier for identifying the second settlement service provider available to the second user U2 to the relay server M.

3-(6) The settlement information reception unit 310 of the relay server M receives the settlement information from the second user terminal T2.

3-(7) The settlement request unit 311 of the relay server M transmits the settlement token and the settlement price to the first settlement server Q1 of the first settlement service provider identified by the first service provider identifier acquired from the settlement token included in the settlement information received by the settlement information reception unit 310.

3-(8) The settlement management unit 411 of the first settlement server Q1 performs user authentication by determining whether the settlement token transmitted to the first user terminal T1 matches the settlement token received from the relay server M. The settlement management unit 411 of the first settlement server Q1 acquires the first user identifier associated with the settlement token received from the relay server M from the storage unit 40 under the condition that the settlement token transmitted to the first user terminal T1 matches the settlement token received from the relay server M, determines whether the settlement price can be settled with a balance of an account of the first user U1 identified with the first user identifier, and notifies the relay server M of a result as information regarding a settlement approval.

3-(9) When the settlement price can be settled with the balance of the account of the first user U1, the settlement request unit 311 of the relay server M transmits the second user identifier and a request for settling the settlement price included in the settlement information to the second settlement server Q2 managed by the second settlement service provider. When the settlement price cannot be settled with the balance of the account of the first user U1, the settlement request unit 311 stops the settlement process.

3-(10) The settlement management unit 511 of the second settlement server Q2 performs settlement of the settlement price received from the relay server M under the condition that user authentication based on the second user identifier received from the settlement request unit 311 of the relay server M is successful. Specifically, the settlement management unit 511 makes payment of an amount equivalent to the settlement price to an account opened by the second user U2. This means that the second settlement server Q2 makes the payment on behalf of the first user U1. When the user authentication fails, that is, the second user U2 does not perform user registration with the second settlement service provider, the settlement management unit 511 of the second settlement server Q2 stops the settlement process.

3-(11) The settlement management unit 511 notifies the second user terminal T2 of the completion of the settlement.

3-(12) When a settlement request is transmitted to the second settlement server Q2, the notification unit 312 of the relay server M notifies the first user terminal T1 of the completion of the settlement.

3-(13) The adjustment management unit 512 of the second settlement server Q2 requests the adjustment management unit 412 of the first settlement server Q1 to perform adjustment. As a result, an amount of money equivalent to the settlement price is remitted from the account of the first user U1 managed by the first settlement server Q1 to the second settlement server Q2 and the payment of the second settlement server Q2 on behalf of the first user U1 is adjusted. The relay server M may relay the adjustment process performed between the first settlement server Q1 and the second settlement server Q2. For example, an adjustment relay unit (not illustrated) of the relay server M may receive an adjustment request from the adjustment management unit 512 of the second settlement server Q2 and transmit the adjustment request to the adjustment management unit 412 of the first settlement server Q1.

In this way, the relay server M according to the first embodiment relays the adjustment process performed among the first user terminal T1, the second user terminal T2, the first settlement server Q1, and the second settlement server Q2. Thus, the relay server M can realize the electronic settlement even when the kind of electronic settlement contracted by the first user U1 is different from the kind of electronic settlement contracted by the second user U2.

### Advantageous Effects Obtained by Relay Server M According to First Embodiment

As described above, according to the relay server M according to the embodiment, the user U can carry out the settlement without being aware of the kind of electronic settlement.

### First Modification Example of First Embodiment

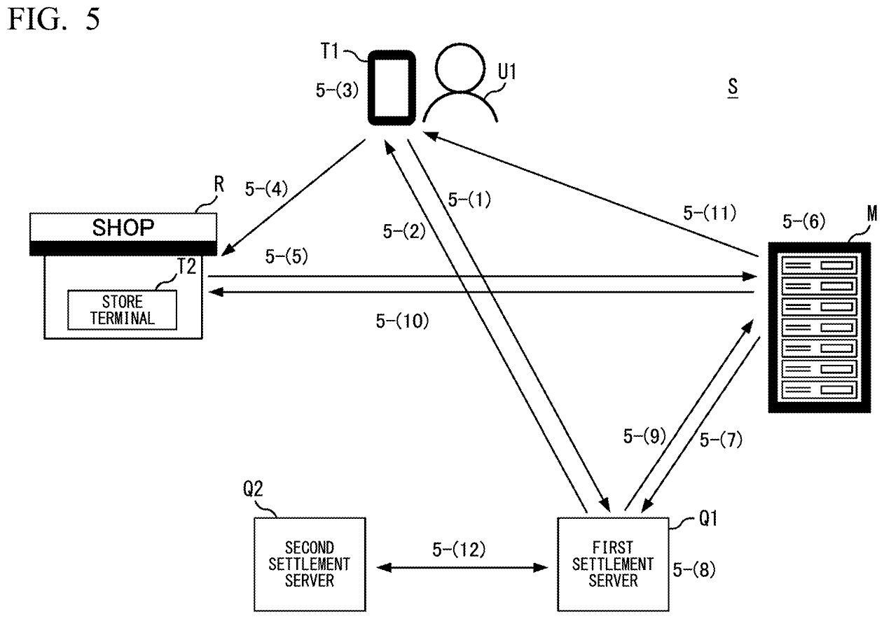

FIG. 5 is a diagram illustrating a settlement process performed by the settlement processing system S according to a first modification example of the first embodiment. The settlement processing system S according to the first modification example of the first embodiment is different from the settlement processing system S according to the first embodiment in that the first settlement server Q1 performs a settlement process based on settlement information.

Hereinafter, a settlement process performed by the settlement processing system S according to the first modification example of the first embodiment will be described in the order of 5-(1) to 5-(12) with reference to FIG. 5. These reference numbers correspond to 5-(1) to 5-(12) in FIG. 5. Since the processes from 5-(1) to 5-(7) are the same as the processes from 3-(1) to 3-(7) in FIG. 3, description thereof will be omitted.

5-(8) The settlement management unit 411 of the first settlement server Q1 performs user authentication by determining whether the settlement token transmitted to the first user terminal T1 matches the settlement token received from the relay server M. The settlement management unit 411 of the first settlement server Q1 acquires the first user identifier associated with the settlement token received from the relay server M from the storage unit 40 under the condition that the settlement token transmitted to the first user terminal T1 matches the settlement token received from the relay server M, determines whether the settlement price can be settled with a balance from the account of the first user U1 identified with the first user identifier, and performs settlement when settlement is possible to withdraw an amount of money equivalent to the settlement price from the account of the first user U1.

5-(9) The settlement management unit 411 of the first settlement server Q1 transmits a settlement result to the relay server M.

5-(10) The notification unit 312 of the relay server M transmits the settlement result received from the first settlement server Q1 to the second user terminal T2.

5-(11) The notification unit 312 of the relay server M transmits the settlement result received from the first settlement server Q1 to the first user terminal T1.

5-(12) The adjustment management unit 412 of the first settlement server Q1 requests the adjustment management unit 512 of the second settlement server Q2 to perform adjustment. As a result, the amount of money equivalent to the settlement price withdrawn from the account of the first user U1 managed by the first settlement server Q1 is paid to the account of the second user U2 managed by the second settlement server Q2. The relay server M may relay the adjustment process performed between the first settlement server Q1 and the second settlement server Q2.

In this way, the settlement processing system S according to the first modification example of the first embodiment is different from the settlement processing system S according to the first embodiment, the first settlement server Q1 of the settlement service provider available to the first user U1 performs a settlement process. Therefore, the settlement processing system S according to the first modification example of the first embodiment can immediately perform the settlement process because the process of notifying the relay server M of a balance confirmation result is omitted when there is a balance equivalent to the payment price in the account of the first user U1. Therefore, it is possible to accelerate the payment process.

In consideration of the settlement processing system S according to the first embodiment and the settlement processing system S according to the first modification example of the first embodiment, it can be said that the settlement request unit 311 of the relay server M may transmit a request for settling the settlement price to one settlement server Q between the first settlement server Q1 and the second settlement server Q2. When one settlement server Q receiving the settlement request performs the settlement process and the other settlement server Q transmits the settlement request, the settlement processing system S can realize the electronic settlement although the kind of electronic settlement contracted by the first user U1 is different from the kind of electronic settlement contracted by the second user U2.

### Second Modification Example of First Embodiment

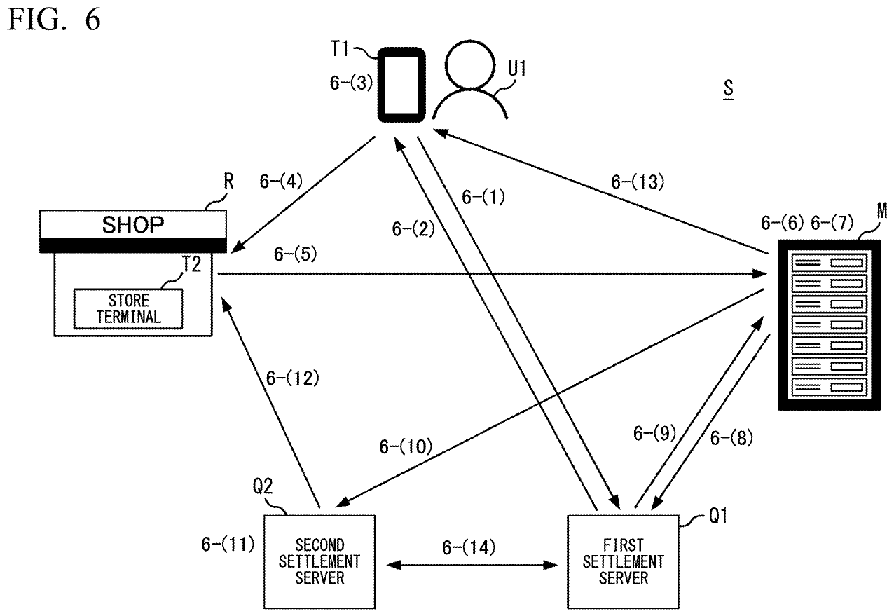

FIG. 6 is a diagram illustrating a settlement process performed by the settlement processing system S according to a second modification example of the first embodiment. The settlement processing system S according to the second modification example of the first embodiment is different from the settlement processing system S according to the first embodiment in that the relay server M encrypts information exchanged between the first user terminal T1 and the first settlement server Q1 with an encryption key used by the first settlement server Q1. The relay server M encrypts information exchanged between the second user terminal T2 and the second settlement server Q2 with an encryption key used by the second settlement server Q2.

Hereinafter, a settlement process performed by the settlement processing system S according to the second modification example of the first embodiment will be described in the order of 6-(1) to 6-(14) with reference to FIG. 6. These reference numbers correspond to 6-(1) to 6-(14) in FIG. 6. Since the process of 6-(1) is the same as the process of 3-(1) in FIG. 3, a description thereof will be omitted.

6-(2) The token transmission unit 410 of the first settlement server Q1 generates a token associated with the first service provider identifier for identifying the first settlement service provider in response to the acquisition request acquired from the first user terminal T1, encrypts the generated settlement token with the encryption key used by the first settlement server Q1, and then transmits the encrypted settlement token to the first user terminal T1. The token transmission unit 410 stores the settlement token transmitted to the first user terminal T1 in the storage unit 40 in association with the first user identifier for identifying the first user U1. The first settlement server Q1 performs user authentication of the user using the first user terminal T1 when there is a request for the token from the token request unit 110 of the first user terminal T1 or before there is the request for the token. Under the condition that the user authentication is successful, the token transmission unit 410 of the first settlement server Q1 generates the settlement token.

6-(3) The display control unit 111 of the first user terminal T1 decodes the encrypted settlement token received from the first settlement server Q1 and displays the settlement code generated based on the obtained settlement token on the display unit of the first user terminal T1.

6-(4) The code reading unit 210 of the second user terminal T2 reads the settlement code displayed on the display unit of the first user terminal T1 to acquire the settlement token.

6-(5) The settlement information transmission unit 211 of the second user terminal T2 encrypts settlement information including the settlement token acquired by the code reading unit 210, the second user identifier for identifying the second user U2 using the second user terminal T2, the settlement price, and the second service provider identifier for identifying the second settlement service provider available to the second user U2 with the encryption key used by the second settlement server Q2 and transmits the encrypted settlement information to the relay server M.

6-(6) The settlement information reception unit 310 of the relay server M receives the encrypted settlement information from the second user terminal T2.

6-(7) The settlement information reception unit 310 decodes the encrypted settlement information received from the second user terminal T2 with the encryption key used by the second settlement server Q2.

6-(8) The settlement request unit 311 of the relay server M encrypts information including the settlement token and the settlement price with the encryption key used by the first settlement server Q1 and transmits the encrypted information to the first settlement server Q1 of the first settlement service provider identified with the first service provider identifier acquired from the settlement token included in the settlement information received by the settlement information reception unit 310.

6-(9) The settlement management unit 411 of the first settlement server Q1 performs user authentication by determining whether the settlement token transmitted to the first user terminal T1 matches the settlement token received from the relay server M. The settlement management unit 411 of the first settlement server Q1 acquires the first user identifier associated with the settlement token from the storage unit 40 by decoding the information received from the relay server M under the condition that the settlement token transmitted to the first user terminal T1 matches the settlement token received from the relay server M. The settlement management unit 411 determines whether the settlement price can be settled with a balance of an account of the first user U1 identified with the first user identifier, encrypts a result, and notifies the relay server M of the encrypted result.

6-(10) The settlement request unit 311 of the relay server M decodes the notification received from the settlement management unit 411 with the encryption key used by the first settlement server Q1. When the settlement price can be settled with the balance of the account of the first user U1 (that is, the user authentication of the first user U1 is successful in the first settlement server Q1 and there is the balance), the settlement request unit 311 of the relay server M encrypts the request for settling the settlement price included in the settlement information and the second user identifier with the encryption key used by the second settlement server Q2 and transmits the encrypted information to the second settlement server Q2 managed by the second settlement service provider.

6-(11) The settlement management unit 511 of the second settlement server Q2 decodes the information received from the relay server M under the condition that user authentication based on the second user identifier received from the settlement request unit 311 of the relay server M is successful, and performs settlement of the settlement price.

6-(12) The settlement management unit 511 encrypts information indicating completion of the settlement with the encryption key used by the second settlement server Q2 and notifies the second user terminal T2 of the encrypted information.

6-(13) When the settlement request is transmitted to the second settlement server Q2, the notification unit 312 of the relay server M encrypts information indicating the completion of the settlement with the encryption key used by the first settlement server Q1 and notifies the first user terminal T1 of the encrypted information.

6-(14) The adjustment management unit 512 of the second settlement server Q2 requests the adjustment management unit 412 of the first settlement server Q1 to perform adjustment. The relay server M may relay an adjustment process performed between the first settlement server Q1 and the second settlement server Q2.

In this way, the relay server M encrypts information exchanged between the first user terminal T1 and the first settlement server Q1 with an encryption key used by the first settlement server Q1. The relay server M encrypts information exchanged between the second user terminal T2 and the second settlement server Q2 with an encryption key used by the second settlement server Q2. Thus, the relay server M can further improve the security of the settlement process.

### Third Modification Example of First Embodiment

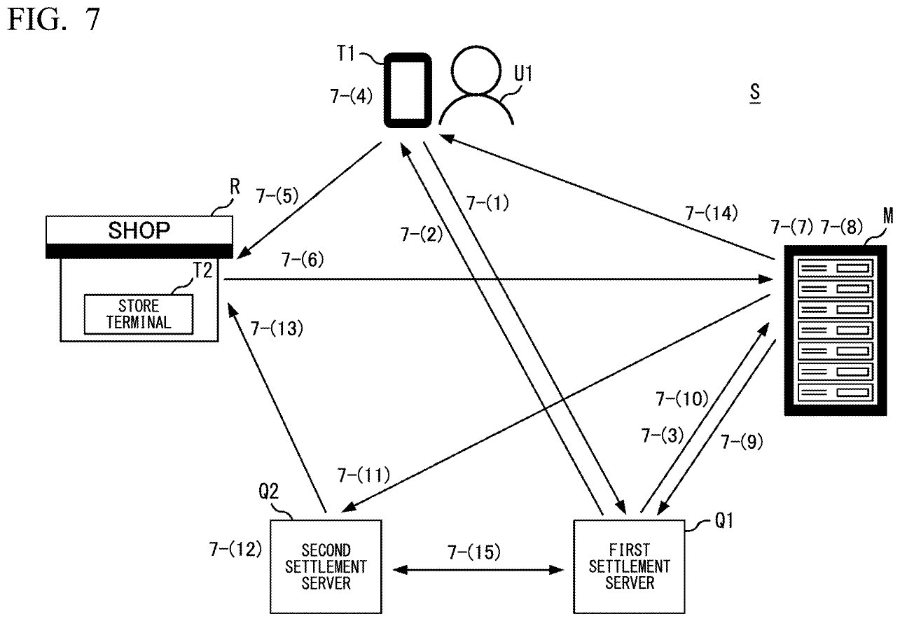

FIG. 7 is a diagram illustrating a settlement process performed by the settlement processing system S according to a third modification example of the first embodiment. The settlement processing system S according to the third modification example of the first embodiment is different from the settlement processing system S according to the first embodiment in that the first settlement server Q1 transmits the generated settlement token to the relay server M.

Hereinafter, a settlement process performed by the settlement processing system S according to the third modification example of the first embodiment will be described in the order of 7-(1) to 7-(15) with reference to FIG. 7. These reference numbers correspond to 7-(1) to 7-(15) in FIG. 7. Since the processes of 7-(1) and 7-(2) are the same as the processes of 3-(1) and 3-(2) in FIG. 3, description thereof will be omitted.

7-(3) The token transmission unit 410 transmits the generated settlement token to the relay server M.

7-(4) The display control unit 111 of the first user terminal T1 displays the settlement code generated based on the settlement token received from the first settlement server Q1 on the display unit of the first user terminal T1.

7-(5) The code reading unit 210 of the second user terminal T2 reads the settlement code displayed on the display unit of the first user terminal T1 to acquire the settlement token.

7-(6) The settlement information transmission unit 211 of the second user terminal T2 transmits settlement information including the settlement token acquired by the code reading unit 210, the second user identifier for identifying the second user U2 using the second user terminal T2, the settlement price, and the second service provider identifier for identifying the second settlement service provider available to the second user U2 to the relay server M.

7-(7) The settlement information reception unit 310 of the relay server M receives the settlement information from the second user terminal T2.

7-(8) The settlement request unit 311 of the relay server M stops the settlement process when the settlement token received from the first settlement server Q1 does not match the settlement token received from the second user terminal T2. Specifically, the settlement request unit 311 determines that the settlement tokens do not match when the settlement token received from the second user terminal T2 is not included as one settlement token whose a valid period has not expired among the settlement tokens received from the first settlement server Q1.

7-(9) When the settlement token received from the first settlement server Q1 matches the settlement token received from the second user terminal T2, the settlement request unit 311 of the relay server M transmits the settlement token and the settlement price to the first settlement server Q1.

7-(10) The settlement management unit 411 of the first settlement server Q1 acquires the first user identifier associated with the settlement token received from the relay server M from the storage unit 40, determines whether the settlement price can be settled with a balance of an account of the first user U1 identified with the first user identifier, and notifies the relay server M of a result.

7-(11) When the settlement price can be settled with the balance of the account of the first user U1, the settlement request unit 311 of the relay server M transmits a request for settling the settlement price included in the settlement information to the second settlement server Q2 managed by the second settlement service provider.

7-(12) The settlement management unit 511 of the second settlement server Q2 performs settlement of the settlement price received from the relay server M. Specifically, the settlement management unit 511 makes payment of an amount equivalent to the settlement price to an account opened by the second user U2.

7-(13) The settlement management unit 511 notifies the second user terminal T2 of the completion of the settlement.

7-(14) When a settlement request is transmitted to the second settlement server Q2, the notification unit 312 of the relay server M notifies the first user terminal T1 of the completion of the settlement.

7-(15) The adjustment management unit 512 of the second settlement server Q2 requests the adjustment management unit 412 of the first settlement server Q1 to perform adjustment. As a result, an amount of money equivalent to the settlement price is remitted from the account of the first user U1 managed by the first settlement server Q1 to the second settlement server Q2. The relay server M may relay the adjustment process performed between the first settlement server Q1 and the second settlement server Q2.

In this way, in the relay server M according to the third modification example of the first embodiment, the settlement request unit 311 stops the settlement process when the settlement token received from the first settlement server Q1 does not match the settlement token received from the second user terminal T2. Thus, since the relay server M can inhibit the first settlement server Q1 from performing a process such as balance confirmation, a load on the first settlement server Q1 can be reduced.

The first settlement server Q1 may not include the first service provider identifier in the settlement token generated in response to the request for acquiring the settlement token of the first user terminal T1. In this case, when the settlement token is received from the first settlement server Q1, the relay server M stores the received settlement token in the storage unit 30 in association with the first service provider identifier. The relay server M can identify the settlement service provider available to the first user U1 by reading the settlement token matching the settlement token included in the settlement information received from the second user terminal T2 from the storage unit 30 and acquiring the first service provider associated with the settlement token.

### Fourth Modification Example of First Embodiment

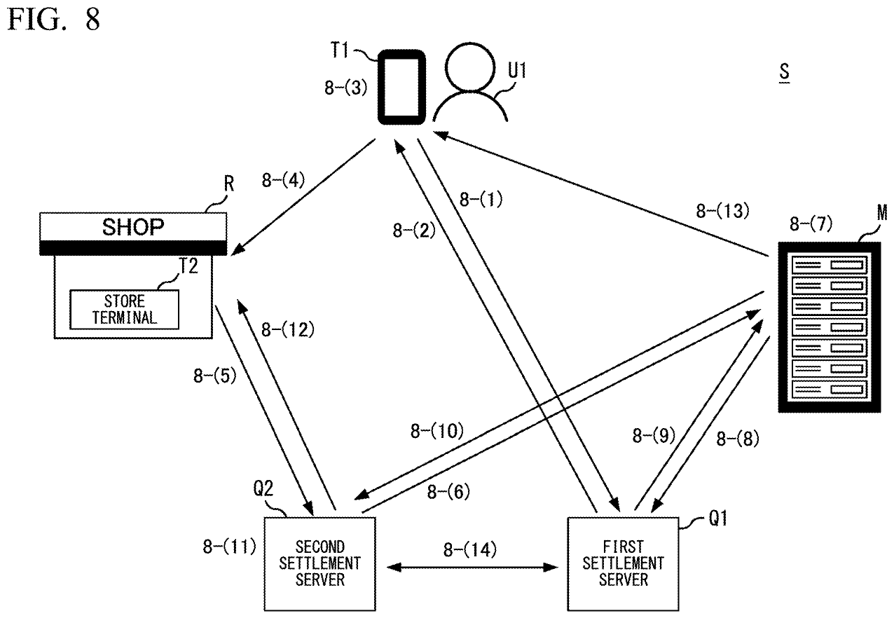

FIG. 8 is a diagram illustrating a settlement process performed by the settlement processing system S according to a fourth modification example of the first embodiment. The settlement processing system S according to the fourth modification example of the first embodiment is different from the settlement processing system S according to the first embodiment in that the second user terminal T2 reading the settlement code transmits the settlement information to the second settlement server Q2 rather than the relay server M.

Hereinafter, a settlement process performed by the settlement processing system S according to the fourth modification example of the first embodiment will be described in the order of 8-(1) to 8-(14) with reference to FIG. 8. These reference numbers correspond to 8-(1) to 8-(14) in FIG. 8. Since the processes of 8-(1) to 8-(4) are the same as the processes of 3-(1) to 3-(4) in FIG. 3, a description thereof will be omitted.

8-(5) The settlement information transmission unit 211 of the second user terminal T2 transmits the settlement information including the settlement token and the settlement price acquired by the code reading unit 210 to the second settlement server Q2.

8-(6) The settlement management unit 511 of the second settlement server Q2 transmits the settlement information received from the second user terminal T2 to the relay server M when the settlement token included in the settlement information received from the second user terminal T2 is different from the settlement token used by the second settlement server Q2.

8-(7) The settlement information reception unit 310 of the relay server M receives the settlement information from the second settlement server Q2.

8-(8) The settlement request unit 311 of the relay server M transmits the settlement token and the settlement price to the first settlement server Q1 of the first settlement service provider identified by the first service provider identifier acquired from the settlement token included in the settlement information received by the settlement information reception unit 310.

8-(9) The settlement management unit 411 of the first settlement server Q1 performs user authentication by determining whether the settlement token transmitted to the first user terminal T1 matches the settlement token received from the relay server M. The settlement management unit 411 of the first settlement server Q1 acquires the first user identifier associated with the settlement token received from the relay server M from the storage unit 40 under the condition that the settlement token transmitted to the first user terminal T1 matches the settlement token received from the relay server M, determines whether the settlement price can be settled with a balance of an account of the first user U1 identified with the first user identifier, and notifies the relay server M of a result as information regarding a settlement approval.

8-(10) When the settlement price can be settled with the balance of the account of the first user U1, the settlement request unit 311 of the relay server M transmits a request for settling the settlement price included in the settlement information to the second settlement server Q2 managed by the second settlement service provider.

8-(11) The settlement management unit 511 of the second settlement server Q2 performs settlement of the settlement price received from the relay server M under the condition that user authentication based on the second user identifier received from the settlement request unit 311 of the relay server M is successful.

8-(12) The settlement management unit 511 notifies the second user terminal T2 of the completion of the settlement.

8-(13) When a settlement request is transmitted to the second settlement server Q2, the notification unit 312 of the relay server M notifies the first user terminal T1 of the completion of the settlement.

8-(14) The adjustment management unit 512 of the second settlement server Q2 requests the adjustment management unit 412 of the first settlement server Q1 to perform adjustment. The relay server M may relay the adjustment process performed between the first settlement server Q1 and the second settlement server Q2.

In this way, in the settlement processing system S according to the fourth modification example of the first embodiment, the second user terminal T2 transmits the settlement information to the second settlement server Q2 rather than the relay server M. The second settlement server Q2 cannot perform the settlement process since the settlement token included in the received settlement information is generated by the first settlement server Q1. Therefore, the settlement information is transmitted to the relay server M. It is not necessary to exchange information between the second user terminal T2 and the relay server M. Therefore, even when the second user U2 does not designate member store registration in the relay server M, the relay server M can relay the settlement process as long as the second settlement server Q2 registers the service provider in the relay server M.

### Fifth Modification Example of First Embodiment

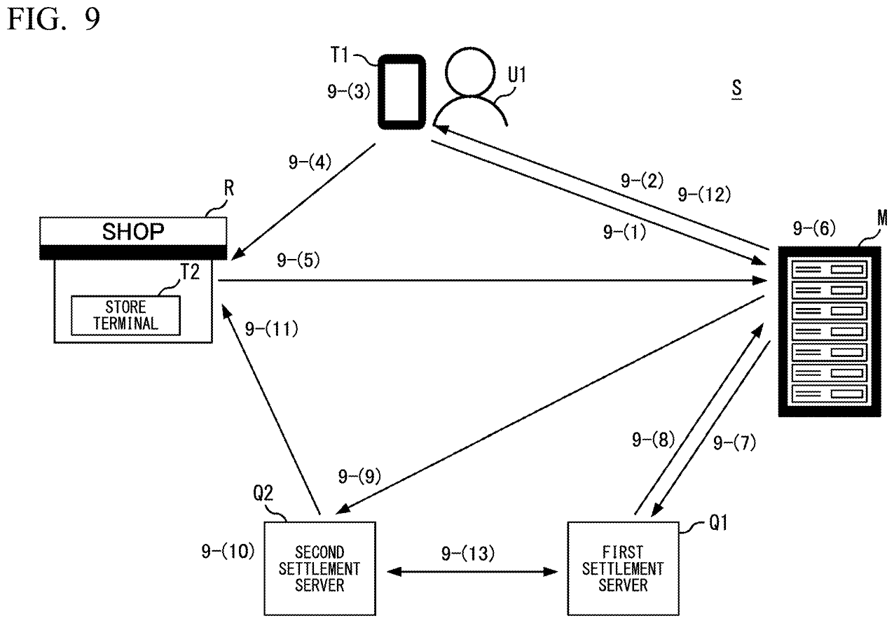

FIG. 9 is a diagram illustrating a settlement process performed by the settlement processing system S according to a fifth modification example of the first embodiment. The settlement processing system S according to the fifth modification example of the first embodiment is different from the settlement processing system S according to the first embodiment in that the first user terminal T1 transmits a request for acquiring the settlement token to the relay server M.

Hereinafter, a settlement process performed by the settlement processing system S according to the fifth modification example of the first embodiment will be described in the order of 9-(1) to 9-(13) with reference to FIG. 9. These reference numbers correspond to 9-(1) to 9-(13) in FIG. 9.

9-(1) The token request unit 110 of the first user terminal T1 transmits a request for acquiring a settlement token for performing settlement using the first settlement server Q1 to the relay server M.

9-(2) The token transmission unit (not illustrated) of the relay server M generates a token associated with the first service provider identifier for identifying the first settlement service provider in response to the acquisition request acquired from the first user terminal T1 and transmits the generated settlement token to the first user terminal T1. The storage unit 30 stores the settlement token transmitted to the first user terminal T1 in association with the first user identifier for identifying the first user U1.

The relay server M performs user authentication of the user using the first user terminal T1 when there is a request for the token from the token request unit 110 of the first user terminal T1 or before there is the request for the token. Specifically, when the first user terminal T1 signs in the relay server M with an identifier associated with the first user identifier, the relay server M can realize the user authentication. When there is a request for the token from the token request unit 110 of the first user terminal T1, the relay server M may consider the user authentication to be successful under the condition that the first service provider identifier is acquired from the token request unit 110. Under the condition that the user authentication is successful, the token transmission unit 410 of the first settlement server Q1 generates the settlement token.

Since the processes of 9-(3) to 9-(13) in FIG. 9 are the same as the processes of 3-(3) to 3-(13) in FIG. 3, description thereof will be omitted. In the settlement processing system S according to the fifth modification example of the first embodiment, the relay server M generates the settlement token when there is a request for acquiring the settlement token from the user terminal T in the user registration in the relay server M. In this way, since the relay server M is in charge of a part of the settlement token generation process, the settlement processing system S according to the fifth modification example of the first embodiment can distribute a processing load on the first settlement server Q1.

### Sixth Modification Example of First Embodiment

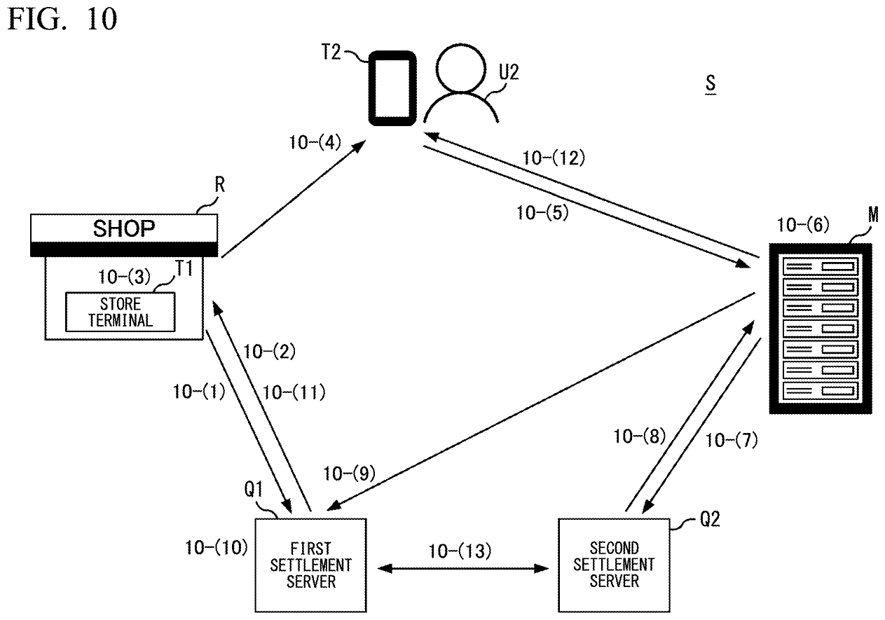

FIG. 10 is a diagram illustrating a settlement process performed by the settlement processing system S according to a sixth modification example of the first embodiment. Specifically, the settlement processing system S according to the sixth modification example is a settlement system in conformity with the store suggestion scheme. Accordingly, the first user terminal T1 is a store terminal and the first user U1 is a manager or the like of a store R in which the store terminal is installed. A customer of the store R is the second user U2 and a user terminal of the second user U2 is the second user terminal T2.

Hereinafter, a settlement process performed by the settlement processing system 5 according to the sixth modification example of the first embodiment will be described in the order of 10-(1) to 10-(13) with reference to FIG. 10. These reference numbers correspond to 10-(1) to 10-(13) in FIG. 10.

10-(1) The token request unit 110 of the first user terminal T1 transmits a request for acquiring the settlement token to the first settlement server Q1 managed by the first settlement service provider available to the first user U1.

10-(2) The token transmission unit 410 of the first settlement server Q1 generates a token associated with the first service provider identifier for specifying the first settlement service provider in response to the acquisition request acquired from the first user terminal T1 and transmits the acquired token to the first user terminal T1.

10-(3) The display control unit 111 of the first user terminal T1 displays the settlement code generated based on the settlement token received from the first settlement server Q1 on the display unit of the first user terminal T1.

10-(4) The code reading unit 210 of the second user terminal T2 reads the settlement code displayed on the display unit of the first user terminal T1 to acquire the settlement token.

10-(5) The settlement information transmission unit 211 of the second user terminal T2 transmits settlement information including the settlement token acquired by the code reading unit 210, a second user identifier for identifying the second user U2 using the second user terminal T2, a settlement price, and a second service provider identifier for identifying the second settlement service provider available to the second user U2 to the relay server M.

10-(6) The settlement information reception unit 310 of the relay server M receives the settlement information from the second user terminal T2.

10-(7) The settlement request unit 311 of the relay server M transmits the settlement price and the second user identifier for specifying the second user U2 to the second settlement server Q2 of the second settlement service provider with which the second user U2 carrying the second user terminal T2 makes a contract.

10-(8) The settlement management unit 511 of the second settlement server Q2 performs user authentication using the second user identifier received from the relay server M. When the authentication is successful, the settlement management unit 511 of the second settlement server Q2 determines whether the settlement price can be settled with a balance of an account of the second user U2 specified with the second user identifier and notifies the relay server M of a result.

10-(9) When the settlement price can be settled with the balance of the account of the second user U2, the settlement request unit 311 of the relay server M transmits a request for settling the settlement price included in the settlement information to the first settlement server Q1 managed by the first settlement service provider.

10-(10) The settlement management unit 411 of the first settlement server Q1 performs settlement of the settlement price received from the relay server M. Specifically, the settlement management unit 411 makes payment of an amount equivalent to the settlement price on an account opened by the first user U1.

10-(11) The settlement management unit 411 notifies the first user terminal T1 of the completion of the settlement.

10-(12) When a settlement request is transmitted to the first settlement server Q1, the notification unit 312 of the relay server M notifies the second user terminal T2 of the completion of the settlement.

10-(13) The adjustment management unit 412 of the first settlement server Q1 requests the adjustment management unit 512 of the second settlement server Q2 to perform adjustment. As a result, an amount of money equivalent to the settlement price is remitted from the account of the second user U2 managed by the second settlement server Q2 to the first settlement server Q1. The relay server M may relay the adjustment process performed between the first settlement server Q1 and the second settlement server Q2.

Thus, the settlement processing system S can realize the electronic settlement even when the kind of electronic settlement contracted by the first user U1 is different from the kind of electronic settlement contracted by the second user U2.

### Second Embodiment

### Overview of Second Embodiment

An overview of a second embodiment will be described. A settlement processing system S according to the second embodiment is a settlement system in conformity with the store suggestion scheme. Accordingly, in the settlement processing system S according to the second embodiment, the first user terminal T1 is a store terminal installed in a store R and the second user terminal is a customer terminal carried by a customer using the store R. Hereinafter, in the settlement processing system S according to the second embodiment, a store terminal which is the first user terminal T1 is referred to as a “store terminal T1” and a customer terminal which is the second user terminal T2 is referred to as a “customer terminal T2.”

In the customer terminal T2 according to the second embodiment, a code generation algorithm used in a plurality of different settlement server Q and application software (hereinafter referred to as a “settlement app”) that has an encryption key are installed in advance. Specifically, when an owner of the customer terminal T2 carries out user registration with the relay server M, the customer terminal T2 can download the settlement app from the relay server M.

Since the customer terminal T2 according to the second embodiment has the settlement app, the customer terminal T2 can encode a settlement token read from the store terminal T1 using an algorithm used by the settlement server Q using the settlement token or can encrypt the settlement token with an encryption key used by the settlement server Q. In the settlement processing system S according to the second embodiment, the customer terminal T2 converts information received from the store terminal T1 into information which can be handled by the first settlement server Q1 and encrypts the converted information with an encryption key used by the first settlement server Q1. From this viewpoint, the settlement processing system S is different from the settlement processing system S according to particularly the second modification example of the first embodiment.

Hereinafter, a functional configuration of each device included in the settlement processing system S according to the second embodiment and a settlement process performed by the settlement processing system S according to the second embodiment will be described. The repeated description of the settlement processing system S according to the first embodiment or the various modification examples will be appropriately omitted or described in brief.

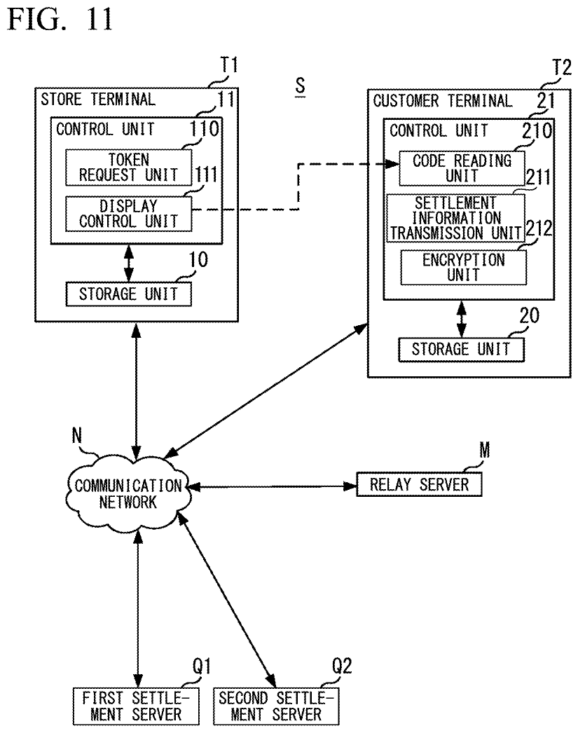

FIG. 11 is a block diagram schematically illustrating a functional configuration of each device included in the settlement processing system S according to a second embodiment. In FIG. 11, since the relay server M, the first settlement server Q1, and the second settlement server Q2 have the same functional configurations as the relay server M, the first settlement server Q1, and the second settlement server Q2 according to the first embodiment illustrated in FIG. 2, detailed illustration is omitted. As illustrated in FIG. 11, the control unit 21 of the customer terminal T2 according to the second embodiment is different from the second user terminal T2 according to the first embodiment in that an encryption unit 212 is included.

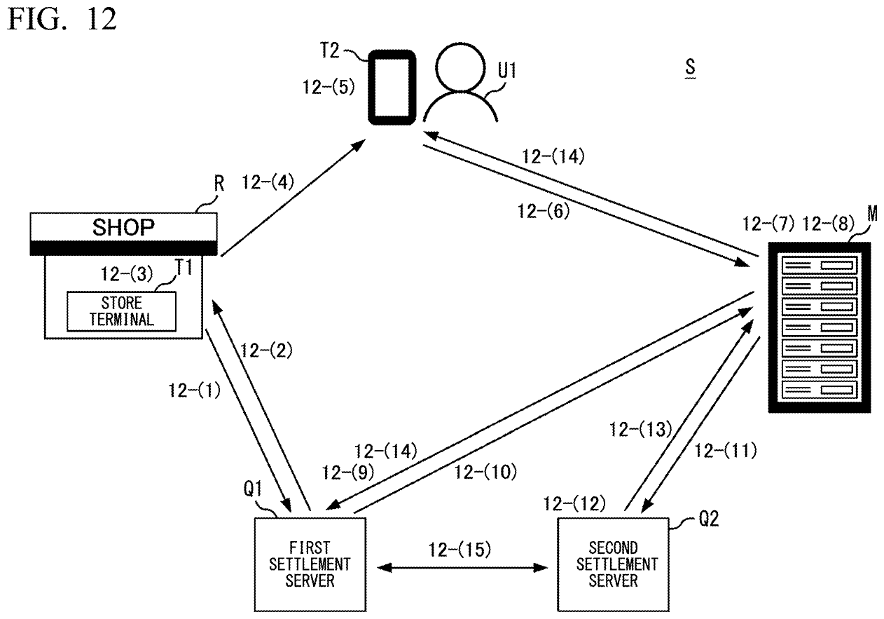

FIG. 12 is a diagram illustrating a settlement process performed by the settlement processing system S according to the second embodiment. Hereinafter, a settlement process performed by the settlement processing system S according to the second embodiment will be described in the order of 12-(1) to 12-(15) with reference to FIGS. 11 and 12. These reference numbers correspond to 12-(1) to 12-(15) in FIG. 12.

12-(1) The token request unit 110 of the store terminal T1 transmits a request for acquiring a settlement token to the first settlement server Q1 managed by the first settlement service provider available to the manager or the store R in which the store terminal T1 is installed.

12-(2) The token transmission unit 410 of the first settlement server Q1 generates a token associated with a first service provider identifier for identifying the first settlement service provider in response to the acquisition request acquired from the store terminal T1 and transmits the token to the store terminal T1.

12-(3) The display control unit 111 of the store terminal T1 displays the settlement code generated based on the settlement token received from the first settlement server Q1 on the display unit of the store terminal T1.

12-(4) The code reading unit 210 of the second user terminal T2 reads the settlement code displayed on the display unit of the store terminal T1 to acquire the settlement token.

12-(5) The encryption unit 212 of the customer terminal T2 encrypts the settlement information including the second service provider identifier for identifying the second settlement service provider available to a customer carrying the customer terminal T2, the settlement token, and the settlement price with the encryption key used by the first settlement server Q1 which is a settlement server of the first settlement service provider.

12-(6) The settlement information transmission unit 211 of the customer terminal T2 transmit the settlement information encrypted by the encryption unit 212 to the relay server M.

12-(7) The settlement information reception unit 310 of the relay server M receives the encrypted settlement information from the customer terminal T2.

12-(8) The encryption unit 212 of the relay server M decodes the settlement information received from the customer terminal T2 to acquire the first service provider identifier included in the settlement token.

12-(9) The settlement request unit 311 of the relay server M transmits the encrypted settlement information acquired from the customer terminal T2 to the first settlement server Q1.

12-(10) The settlement management unit 411 of the first settlement server performs user authentication of the customer who is the user of the store terminal T1 based on the settlement information transmitted from the relay server M and transmits an authentication result to the relay server M. Specifically, when the settlement token transmitted to the store terminal T1 by the token transmission unit 410 matches the settlement token included in the settlement information received from the relay server M, the settlement management unit 411 of the first settlement server determines the authentication of the customer is successful.

12-(11) When the authentication is successful, the settlement request unit 311 of the relay server M transmits a request for settling the settlement price to the second settlement server Q2.

12-(12) When the settlement can be paid with the balance of the account of the customer, the settlement management unit 511 of the second settlement server Q2 performs the settlement.

12-(13) The settlement management unit 511 of the second settlement server Q2 transmits a notification indicating completion of the settlement to the relay server M.

12-(14) The notification unit 312 of the relay server M notifies the first settlement server Q1 and the customer terminal T2 of the completion of the settlement.

12-(15) The adjustment management unit 412 of the first settlement server Q1 requests the adjustment management unit 512 of the second settlement server Q2 to perform adjustment. As a result, an amount of money equivalent to the settlement price is remitted from the account of the customer managed by the second settlement server Q2 to the first settlement server Q1. The relay server M may relay the adjustment process performed between the first settlement server Q1 and the second settlement server Q2.

### Advantageous Effects Obtained by Settlement Processing System S According to Second Embodiment

As described above, according to the settlement processing system S according to the second embodiment, the user U can carry out the settlement without being aware of the kind of electronic settlement.

In particular, in the settlement processing system S according to the second embodiment, the customer terminal T2 converts the information received from the store terminal T1 into the information which can be handled by the first settlement server Q1 or encrypts the converted information with the encryption key used by the first settlement server Q1. In the settlement processing system S according to the second embodiment, the customer terminal T2 subrogates some of the processes which are performed by the relay server M or the settlement server Q. Therefore, a load can be distributed in the entire system.

### First Modification Example of Second Embodiment

As described above, the second settlement server Q2 performs the settlement based on the settlement information and the first settlement server Q1 is requested to perform the adjustment later. Instead of this, the first settlement server Q1 may perform the settlement based on the settlement information and the second settlement server may be requested to perform the adjustment later. That is, it can be said that the settlement request unit 311 of the relay server M can transmit a request for settling the settlement price to one settlement server Q between the first settlement server Q1 and the second settlement server Q2. When one settlement server Q receiving the settlement request performs the settlement process and the adjustment request is transmitted to the other settlement server Q, the settlement processing system S can realize the electronic settlement although the kind of electronic settlement for which the manager of the store R makes the contract is different from the kind of electronic settlement for which the customer makes the contract.

### Second Modification Example of Second Embodiment

The settlement processing system S according to the second modification example of the second embodiment is different from the settlement processing system S according to the second embodiment in that the first settlement server Q1 transmits the generated settlement token to the relay server M.

In the relay server M according to the second modification example of the second embodiment, the settlement request unit 311 stops the settlement process when the settlement token received from the first settlement server Q1 does not match the settlement token received from the customer terminal T2. More specifically, the relay server M receives a settlement token encrypted with the encryption key used by the first settlement server Q1 from the first settlement server Q1 and acquires the settlement token by performing decoding using the same encryption key. The relay server M receives the settlement information encrypted with the encryption key used by the first settlement server Q1 from the customer terminal T2, decodes the settlement information using the same encryption code, and then extracts the settlement token. The relay server M compares the settlement token originating from the first settlement server Q1 with the settlement token originating from the customer terminal T2 and determines whether both the settlement tokens match each other. Thus, since the relay server M performs a process equivalent to the authentication process for the store terminal T1 by the first settlement server Q1, a load on the first settlement server Q1 can be reduced.

### Third Modification Example of Second Embodiment

The settlement processing system S according to the third modification example of the second embodiment is different from the settlement processing system S according to the second embodiment in that the store terminal T1 transmits a request for acquiring the settlement token to the relay server M. Thus, since the relay server M can be in charge of a part of the settlement token generation process, the settlement processing system S according to the third modification example of the second embodiment can distribute a processing load on the first settlement server Q1.

The embodiments of the present invention have been described, but the technical scope of the present invention is not limited to the scope describe in the foregoing embodiments and various modifications and changes can be made within the scope of the gist of the present invention. For example, specific embodiments of distribution and integration of devices are not limited to the foregoing embodiments and all or some of the specific embodiments can be distributed or integrated functionally or physically in any units. New embodiments obtained in any combination of the plurality of embodiments are also included in the embodiments of the present invention. Advantageous effects obtained in the combination include the advantageous effects of the original embodiments.

### REFERENCE SIGNS LIST

T1 First user terminal
10 Storage unit
11 Control unit
110 Token request unit
111 Display control unit
T2 Second user terminal
20 Storage unit
21 Control unit
210 Code reading unit
211 Settlement information transmission unit
212 Encryption unit
M Relay server
30 Storage unit
31 Control unit
310 Settlement information reception unit
311 Settlement request unit
312 Notification unit
Q1 First settlement server
40 Storage unit
41 Control unit
410 Token transmission unit
411 Settlement management unit
412 Adjustment management unit
Q2 Second settlement server
50 Storage unit
51 Control unit
510 Token transmission unit
511 Settlement management unit
512 Adjustment management unit
N Communication network
S Settlement processing system

1. A settlement processing method comprising:
transmitting a request for acquiring a settlement token to a first settlement server managed by a first settlement service provider available to a first user by a first user terminal used by the first user;
transmitting a settlement token associated with a first service provider identifier for identifying the first settlement service provider to the first user terminal by the first settlement server;
displaying a settlement code generated on the basis of the settlement token by the first user terminal;
transmitting settlement information including a settlement token and a settlement price obtained by reading the settlement code to a relay server by a second user terminal registered in a second settlement server managed by a second settlement service provider different from the first settlement service provider;
acquiring the first service provider identifier associated with the settlement token by the relay server;
transmitting the settlement token to the first settlement sever generating the settlement token by the relay server; and
performing user authentication of the first user on the basis of the settlement token by the first settlement server.

2. A settlement processing method comprising:
transmitting a request for acquiring a settlement token to a first settlement server managed by a first settlement service provider available to a first user by a first user terminal used by the first user;
transmitting a token associated with a first service provider identifier for identifying the first settlement service provider to the first user terminal by the first settlement server;
displaying a settlement code generated on the basis of the settlement token by the first user terminal;
transmitting settlement information including a settlement token and a settlement price obtained by reading the settlement code to a second settlement server managed by a second settlement service provider available to a second user using a second user terminal by the second user terminal;
transmitting the settlement information received to a relay server by the second settlement server by the second user terminal;
extracting the first service provider identifier from the settlement token included in the settlement information received from the second settlement server by the relay server;
transmitting the settlement token to the first settlement server managed by the first settlement service provider identified with the first service provider identifier by the relay server; and
authenticating the first user on the basis of the settlement token by the first settlement server.

3. A settlement processing method comprising:
transmitting a request for acquiring a settlement token to a first settlement server managed by a first settlement service provider available to a first user by a first user terminal used by the first user;
encrypting a settlement token associated with a first service provider identifier for identifying the first settlement service provider using a first encryption key which is an encryption key used by the first settlement server and transmitting the encrypted settlement token to the first user terminal by the first settlement server;
decoding the encrypted settlement token received from the first settlement server using the first encryption key by the first user terminal;
displaying a settlement code generated on the basis of the settlement token by the first user terminal;
encrypting settlement information including a settlement token and a settlement price obtained by reading the settlement code using a second encryption key which is an encryption key used by the first settlement server and transmitting the encrypted settlement information to a relay server by a second user terminal registered in a second settlement server managed by a second settlement service provider different from the first settlement service provider;
decoding the encrypted settlement information received from the second user terminal using the second encryption key by the relay server;
acquiring the first service provider identifier associated with the settlement token included in the settlement information obtained through the decoding by the relay server;
encrypting the settlement token included in the decoded settlement information using the first encryption key by the relay server;
transmitting the encrypted settlement token to the first settlement server generating the settlement token by the relay server;
decoding the encrypted settlement token acquired from the relay server using the first encryption key by the first settlement server; and
performing user authentication of the first user on the basis of the decoded settlement token by the first settlement server.

4. The settlement processing method according to claim 1, further comprising:
generating a token associated with the first service provider identifier for identifying the first settlement service provider and transmitting the token to the relay server by the first settlement server; and
stopping the settlement process by the relay server when the settlement token received from the first settlement server does not match the settlement token received from the second user terminal.

5.-10. (canceled)

11. The settlement processing method according to claim 2, further comprising:
generating a token associated with the first service provider identifier for identifying the first settlement service provider and transmitting the token to the relay server by the first settlement server; and
stopping the settlement process by the relay server when the settlement token received from the first settlement server does not match the settlement token received from the second user terminal.

12. The settlement processing method according to claim 3, further comprising:
generating a token associated with the first service provider identifier for identifying the first settlement service provider and transmitting the token to the relay server by the first settlement server; and
stopping the settlement process by the relay server when the settlement token received from the first settlement server does not match the settlement token received from the second user terminal.
